(19) United States
(12) Patent Application Publication
(10) Pub. No.: US 2025/0181525 A1
(43) Pub. Date: Jun. 5, 2025

(54) DIGITAL SIGNAL INTERCONNECTION

(71) Applicant: Infineon Technologies AG, Neubiberg (DE)

(72) Inventor: Martin BARTH, Passau (DE)

(21) Appl. No.: 18/961,963

(22) Filed: Nov. 27, 2024

(30) Foreign Application Priority Data
Dec. 1, 2023 (DE) 102023212091.7

(51) Int. Cl. G06F 13/14

(52) U.S. Cl. CPC G06F 13/14; G06F 2211/005

(57) ABSTRACT

An electronic control unit is presented. The electronic control unit comprises: a plurality of digital drivers, each digital driver being configured for controlling at least one load; a central microcontroller configured for controlling the digital drivers; and an interconnection for communication between the central microcontroller and the digital drivers, the interconnection comprising: at least one serial bus configured for transmitting digital signals between the central microcontroller and the digital drivers; and at least one communication protocol comprising a set of commands and a set of addresses for communication. Further, a method for controlling a load by using the electronic control unit as well as a use for an automotive application of the electronic control unit and the method are presented.

### TECHNICAL FIELD

The present disclosure relates to an electronic control unit, a method for controlling a load by using an electronic control unit and a use thereof.

### BACKGROUND

An increase of electronic components within an interconnected system, e.g. within an automobile, typically strongly increases complexity of the system. The components typically have to be connected to a central microcontroller and further typically also have to be controlled by the central microcontroller. This may lead to a shortage of available hardware resources, such as interfaces or pins or analog-to-digital converters. It may further specifically increase software complexity, e.g. due to multiple real time critical tasks.

### SUMMARY

In a first aspect, an electronic control unit is presented. The electronic control unit comprises:
a plurality of digital drivers, each digital driver being configured for controlling at least one load;
a central microcontroller configured for controlling the digital drivers; and
an interconnection for communication between the central microcontroller and the digital drivers, the interconnection comprising:
   at least one serial bus configured for transmitting digital signals between the central microcontroller and the digital drivers; and
   at least one communication protocol comprising a set of commands and a set of addresses for communication.

In a further aspect, a method for controlling a load by using an electronic control unit is presented. The method comprises:
a) generating a command by using a central microcontroller of the electronic control unit;
b) sending the command to a digital driver of the electronic control unit by transmitting a digital signal via a serial bus of the electronic control unit; and
c) executing the command in the digital driver for controlling the load.

In a further aspect, a use of the electronic control unit or the method for controlling a load by using an electronic control is presented for an automotive application.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 schematically illustrates an exemplary embodiment of an electronic control unit according to the present disclosure; and

FIG. 2 illustrates a flow chart of an exemplary embodiment of a method for controlling a load by using an electronic control unit according to the present disclosure.

### DETAILED DESCRIPTION

In a first aspect, an electronic control unit is presented. The term “electronic control unit” may also be abbreviated by the term “ECU”. The term “electronic control unit”, in short “ECU”, as generally used herein is a broad term and is to be given its ordinary and customary meaning to a person of ordinary skill in the art and is not to be limited to a special or customized meaning. The electronic control unit may be an electronic device or an electronic system which may be configured for controlling or regulating or managing at least one further electronic device or electronic system. The electronic control unit may be an embedded system, specifically in an automotive application, such as in an automobile or in a part thereof. Thus, the electronic control unit may be an automotive electronic control unit. The electronic control unit may be configured for controlling one or more devices in an automobile, e.g. motor control electronics or power distribution electronics. The electronic control unit may be a zone electronic control unit. Thus, the electronic control unit may be configured for controlling devices in a specific zone or part of an automobile, specifically a spatial part of the automobile or a functional part of the automobile. As an example, the automobile may be divided into a plurality of zones, such as a front, a back, a right side and a left side, wherein each zone may be controlled by one zone electronic control unit. Other zonal architectures may also be feasible. The electronic control unit may also be a central electronic control unit. Thus, the electronic control unit may be configured for directly or indirectly controlling all devices within the automobile. Other applications apart from automotive applications may of course also be feasible.

Generally, the electronic control unit may be configured for receiving and processing input signals, specifically sensor signals. The electronic control unit may be configured for generating output signals for controlling further devices. Thus, the electronic control unit may comprise at least one processor, specifically at least one microprocessor. Specifically, the electronic control unit may be arranged on a printed circuit board (PCB). The electronic control unit may also be arranged on a plurality of PCBs. In other words, the electronic control unit may also be distributed over a plurality of PCBs. Generally, the electronic control unit may also be spatially distributed in an arbitrary fashion. However, specifically, the electronic control unit may be arranged on exactly one PCB. The term “printed circuit board”, in short “PCB”, as generally used herein is a broad term and is to be given its ordinary and customary meaning to a person of ordinary skill in the art and is not to be limited to a special or customized meaning. The PCB may be or may comprise a carrier or a support for one or more electronic components. The PCB may comprise a flat board configured for supporting and/or connecting the electronic components. Thus, the PCB may comprise at least one insulating material such as plastics and/or at least one conducting material such as a metal. The conducting material may be patterned on the insulating material for forming an electronic circuit or at least a part thereof, specifically at least connections between the electronic components.

The electronic control unit comprises a plurality of digital drivers. Each digital driver is configured for controlling at least one load. The term “load” as generally used herein is a broad term and is to be given its ordinary and customary meaning to a person of ordinary skill in the art and is not to be limited to a special or customized meaning. The load may be an electrical load. The load may be a device or a system which consumes electric power. The load may be or may comprise an electronic circuit. The load may be or may comprise at least one of a resistive element, a capacitive element and an inductive element. The load may further comprise at least one mechanical element. The load may comprise a device selected from the group consisting of: a motor, specifically a direct current motor, more specifically a brushed direct current motor or a brushless direct current motor; a switch, specifically a power distribution switch; a sensor; an actuator. Other options may be feasible.

The term “digital driver” as generally used herein is a broad term and is to be given its ordinary and customary meaning to a person of ordinary skill in the art and is not to be limited to a special or customized meaning. The digital driver may be a device which is configured for driving or controlling at least one further device, specifically a switching device, more specifically a transistor. Specifically, the digital driver may be configured for driving or controlling a transistor connected to the load. Thus, the digital driver may be configured for indirectly controlling the load. The digital driver may comprise at least one electronic circuit, specifically an integrated circuit. The digital driver may be a gate driver. Thus, the digital driver may be configured for controlling a switching behavior of a transistor by providing a required voltage and/or current for switching the transistor on and/or off. The digital driver may be configured for regulating the voltage and/or the current which is provided to the transistor. The transistor may be a power transistor. The transistor may be a field-effect transistor or a bipolar transistor. Specifically, the transistor may be a metal-oxide-semiconductor field-effect transistor or an insulated-gate bipolar transistor. Other options may also be feasible. The transistor may be connected to the load and may thus be configured for transferring power to the load.

Being digital, the digital driver may be configured for receiving and processing digital signals. Thus, the digital driver may comprise at least one logic circuit for processing the digital signals. The logic circuit may comprise at least one logic gate, e.g. an OR gate or an AND gate. The logic gate may generally be configured for implementing arbitrary Boolean algebra. The digital driver may be configured for receiving digital signals as an input, specifically from a supervising controller, more specifically from a central microcontroller as will be outlined in further detail below. The digital driver may be configured for processing the digital signals, specifically for generating an output to a further device, such as a transistor. The digital driver may be configured for generating an analog output, such as a continuous voltage or current to a transistor. The digital driver may be configured for generating a digital output, such as a status update to the supervising controller. The digital driver may be or may comprise a microcontroller, specifically a peripheral microcontroller, i.e. a non-central microcontroller. Thus, the digital driver may in principle be programmable, specifically re-programmable. However, the digital driver may specifically also be non-programmable.

The term “digital signal” as generally used herein is a broad term and is to be given its ordinary and customary meaning to a person of ordinary skill in the art and is not to be limited to a special or customized meaning. A digital signal may specifically refer to a piece of information represented in a discrete or quantized fashion, such as by using binary digits, also referred to as bits. Thus, the digital signal may by represented by a sequence of discrete values or a string of discrete values. Typically, “0” and “1” may be used as binary digits. Thus, the digital signal may be a binary signal. The digital signal may generally have a finite number of possible values. The digital signal may be or may comprise a discrete electrical signal, e.g. a voltage with two voltage values denoted with “HIGH” and “LOW” and steep edges for transition between the two voltage values. The digital signal may be or a plurality of digital signals may form at least one data package, such as a data package exchanged in a network. The digital signal may be a non-analog signal. The term “analog signal” as generally used herein is a broad term and is to be given its ordinary and customary meaning to a person of ordinary skill in the art and is not to be limited to a special or customized meaning. An analog signal may specifically refer to a piece of information represented in a continuous fashion, e.g. by using a continuous voltage or current. Thus, the analog signal may be a continuous electrical signal, e.g. a continuous voltage or current. The analog signal may comprise an infinite number of possible values. The values may further continuously change over time.

The electronic control unit comprises a central microcontroller. The central microcontroller is configured for controlling the digital drivers. The term “central microcontroller” as generally used herein is a broad term and is to be given its ordinary and customary meaning to a person of ordinary skill in the art and is not to be limited to a special or customized meaning. The central microcontroller may be a device configured for controlling or regulating or managing at least one further device, specifically also including further microcontrollers such as peripheral microcontrollers. The central microcontroller may be a computing device. The central microcontroller may be programmable, specifically re-programmable. The central microcontroller may comprise at least one software element, such as a software program. The central microcontroller may be or may comprise at least one electronic circuit, specifically an integrated circuit. The central microcontroller may comprise at least one processor, specifically a central processing unit. The central microcontroller may comprise at least one clock. The clock may be configured for providing a clock signal, specifically a global clock signal for the electronic control unit. At least one digital driver may comprise at least one further clock. The central microcontroller may be a digital central microcontroller, specifically a purely digital central microcontroller, i.e. a non-analog central microcontroller. Thus, analog-to-digital converters and/or digital-to-analog converters may not be required for the central microcontroller and can be saved reducing complexity and cost.

Being central, the central microcontroller may be a supervising controller, specifically a supervising controller of the digital drivers. Thus, the central microcontroller may be configured for sending digital signals, specifically commands, to the digital drivers. The central microcontroller may be configured for receiving and processing digital signals from the digital drivers, e.g. a status information. The central microcontroller may be a main microcontroller, specifically a main microcontroller of the electronic control unit. The central microcontroller may be the most high-ranking microcontroller of the electronic control unit. The central microcontroller may be connected to all digital drivers of the electronic control unit. The central microcontroller may be a master of the digital drivers in a master-slave-configuration. The digital drivers may be slaves of the central microcontroller in a master-slave-configuration.

The electronic control unit comprises an interconnection for communication between the central microcontroller and the digital drivers. The term “interconnection” as generally used herein is a broad term and is to be given its ordinary and customary meaning to a person of ordinary skill in the art and is not to be limited to a special or customized meaning. The interconnection may comprise at least one interface between a plurality of devices, specifically between the central microcontroller and the digital drivers. Thus, the interconnection may be configured for interconnecting the devices at least partially, such that the devices can communicate with each other at least partially. The interconnection may comprise a plurality of connections, wherein each connection may again connect a plurality of devices. Thus, the interconnection may at least partially interconnect groups of devices. Such a group may be or may form a network, as will also be outlined in further detail below. Specifically, the interconnection may connect the central microcontroller to all digital drivers. Thus, the central microcontroller may be configured for communicating with all digital drivers via the interconnection. The digital drivers may at least partially be configured for communicating with each other via the interconnection. Specifically, digital drivers which are interconnected in one group may be configured for communicating with each other directly and/or indirectly via the central microcontroller by using the interconnection. Digital drivers of different groups may be configured for communicating with each other indirectly via the central microcontroller or not at all.

The interconnection comprises at least one serial bus. The serial bus is configured for transmitting digital signals between the central microcontroller and the digital drivers. As said, the electronic control unit may be arranged on a PCB. Thus, the digital drivers, the central microcontroller and the interconnection, specifically the serial bus, may all be arranged on the PCB. The term “serial bus” as generally used herein is a broad term and is to be given its ordinary and customary meaning to a person of ordinary skill in the art and is not to be limited to a special or customized meaning. The serial bus may be an interface or a communication connection between a plurality of devices, specifically between the central microcontroller and at least a group of digital drivers. The serial bus may comprise at least one physical connection between the devices, such as a wired connection, e.g. a trace on the PCB. In contrast to point-to-point connections, all devices may be connected to one serial bus for communication among each other and may thus form one group of interconnected devices or a network as will be outlined in further detail below. Specifically, compared to point-to-point connections, a serial bus may reduce the required space for the electronic control unit on the PCB.

The interconnection may specifically comprise a plurality of serial busses. Specifically, one serial bus may connect the central microcontroller to a group of interconnected digital drivers. Additionally, one further serial bus may connect the central microcontroller to a further group of interconnected digital drivers. The groups may also be networks as will be outlined in further detail below. The serial bus may comprise at least one signal line. Being serial, the serial bus may be configured for transmitting signals sequentially, specifically via the signal line. The serial bus may specifically be a digital serial bus. Thus, the serial bus may be configured for transmitting digital signals bit-by-bit, specifically via the signal line. The serial bus may comprise at least one of a clock line and one or more data lines, e.g. two data lines. The serial bus may be selected from the group consisting of: an inter-integrated circuit (I²C); a universal asynchronous receiver-transmitter (UART); a serial peripheral interface (SPI); or a combination thereof.

The interconnection further comprises at least one communication protocol. The communication protocol comprises a set of commands and a set of addresses for communication. The term “communication protocol” as generally used herein is a broad term and is to be given its ordinary and customary meaning to a person of ordinary skill in the art and is not to be limited to a special or customized meaning. The communication protocol may be a logical connection between a plurality of devices, specifically between the central microcontroller and the digital drivers. The communication protocol may comprise an arrangement or agreement, under which a signal transmission between the devices may take place. The communication protocol may comprise a set of rules for communication between the devices. The communication protocol may be implemented in software and/or in hardware. The communication protocol may specifically define at least one of a format, a syntax, a semantic, a synchronization and an error checking of signals exchanged between the devices. The communication protocol may define a format which is used when transmitting signals, specifically digital signals, such as a role of individual bits within a transmitted bit sequence.

The interconnection may specifically comprise a plurality of communication protocols. In other words, the interconnection may comprise a communication protocol stack or a communication protocol suite. The communication protocol stack may overall enable communication between devices, wherein each one of the communication protocols in the communication protocol stack may target a different aspect of the communication, such as addressing or transport or encryption or error checking. Thus, the communication protocol stack may be layered, e.g. according to the Open Systems Interconnection model (OSI model). In other words, the communication protocol may be layered according to the OSI model.

The electronic control unit may comprise a plurality of networks. The interconnection may comprise a plurality of serial busses and may interconnect the networks. Each network may comprise the central microcontroller, a serial bus and at least one digital driver, specifically a plurality of interconnected digital drivers. In other words, at least one digital driver, specifically at least two digital drivers, and the central microcontroller may form a network, wherein the network may be interconnected through one serial bus. Thus, one serial bus of the plurality of serial busses may be configured for transmitting digital signals within the network. The term “network” as generally used herein is a broad term and is to be given its ordinary and customary meaning to a person of ordinary skill in the art and is not to be limited to a special or customized meaning. The network may be or may comprise a group of interconnected devices, specifically the central microcontroller and at least a group of the digital drivers. Specifically, the network may comprise a group of completely or at least closely interconnected devices. The network may comprise at least one redundant connection between at least two devices. The network may be configured for self-organization, including self-organization in case of a failure event, such as by implementing at least one safe state. The network may use the communication protocol for communication between the devices, specifically in a standardized fashion as will be outlined in further detail below.

In principle, the devices in the network may each be technically different and/or fulfill different purposes independently. However, if required, the devices in the network may also at least partially work together for fulfilling an overall purpose. The devices in one network may also be of the same or at least of similar kind. The digital drivers in one network may all be configured for controlling one type of load, e.g. a brushless direct current motor. Thus, this network may be specialized for controlling this type of load. The digital drivers in a further network may all be configured for controlling a further type of load, e.g. a power distribution switch. Thus, overall, the electronic control unit may comprise a plurality of specialized networks for different types of loads. The digital drivers of one network may not be directly connected to the digital drivers of a further network. The digital drivers of one network may be indirectly connected to the digital drivers of the further network via the central microcontroller. The central microcontroller may be part of all networks. All networks may comprise at least the central microcontroller. Other options may generally also be feasible for an implementation of the networks.

The communication protocol may be a standardized communication protocol. Thus, all components or at least most of the components of the electronic control unit may be configured for using the communication protocol, specifically for communicating with each other by using the standardized communication protocol. The standardized communication protocol may further meet all PCB requirements, such that it can be used by all components there. The standardized communication protocol may be included or defined in a technical standard, specifically in an industry standard, e.g. a technical standard set in the International Organization for Standardization (ISO), in the International Electrotechnical Commission (IEC), in the International Telecommunication Union (ITU), in the European Telecommunication

Standards Institute (ETSI) or in the Institute of Electrical and Electronics Engineers Standards Association (IEEE-SA). Thus, the standardized communication protocol may be configured for usage by a variety of different devices, such as a variety of different types of microcontrollers or drivers. Specifically, the standardized communication protocol may be configured for usage in the entire electronic control unit or on the entire PCB. Thus, at least the central microcontroller and all digital drivers may understand or follow or comply with the standardized communication protocol. This may reduce complexity of the electronic control unit, specifically also on a software side, which may again increase software reliability and reliability overall.

The communication protocol may be a network protocol. Thus, the communication protocol may be configured for usage within at least one network. The term “network protocol” as generally used herein is a broad term and is to be given its ordinary and customary meaning to a person of ordinary skill in the art and is not to be limited to a special or customized meaning. The network protocol may be a communication protocol for signal transmission between devices within a network, specifically between the central microcontroller and the digital drivers within a network. The network protocol may specifically be a communication protocol for digital signal transmission or for data exchange. The network protocol may define a structure of data packages transmitted between the devices as digital signals. The structure may refer to a specification of an address of a recipient or of a sender or to a specification of a data type which is exchanged or to a specification of a data package size or to a specification of error checking measures. As said, the communication protocol may actually be a layered communication protocol stack, e.g. according to the OSI model. Likewise, the network protocol may also actually be a layered network protocol stack. The network protocol may specifically be layered according to the OSI model. Thus, the network protocol may generally be standardized. In other words, the network protocol may specifically be a standardized network protocol. Thus, the network protocol may be included or defined in a technical standard, specifically in an industry standard, e.g. one of the above identified technical standards.

The digital drivers may be network compatible. The term “network compatible”, or grammatical variations thereof, as generally used herein is a broad term and is to be given its ordinary and customary meaning to a person of ordinary skill in the art and is not to be limited to a special or customized meaning. Being network compatible may refer to an ability of a device, specifically of the digital drivers, to function within a network and specifically to communicate within the network. Thus, the digital drivers may be configured for communicating with each other and/or with the central microcontroller within one network. The digital drivers may be smart digital drivers. The digital drivers may specifically be configured for understanding or following or complying with the network protocol. Thus, as already indicated, the digital drivers may comprise required hardware elements for this purpose, such as specific logic circuits, or they may be peripheral microcontrollers.

The interconnection may further comprise at least one point-to-point connection from the central microcontroller to at least one digital driver of the plurality of digital drivers. The term “point-to-point connection” as generally used herein is a broad term and is to be given its ordinary and customary meaning to a person of ordinary skill in the art and is not to be limited to a special or customized meaning. The point-to-point connection may be a connection from a first device, specifically from the central microcontroller, directly to a second device, specifically to a digital driver, and only to the second device. The point-to-point connection may be a physical connection, specifically a wired connection, e.g. a trace on a PCB. The point-to-point connection may be a discrete connection. The interconnection may comprise a plurality of point-to-point connections. Thus, the interconnection may comprise a separate first point-to-point connection from the central microcontroller to a first digital driver, a separate second point-to-point connection from the central microcontroller to a second digital driver and so on. The interconnection may comprise a separate point-to-point connection from the central microcontroller to each digital driver or at least to selected digital drivers, e.g. digital drivers having critical functions which may need to be fail-safe. Each point-to-point connection may connect the central microcontroller to exactly one digital driver.

The point-to-point connection may be configured for serving as a redundancy for the serial bus. The point-to-point connection may be separate from the serial bus. The point-to-point connection may be configured for transmitting analog signals. Additionally or alternatively, the point-to-point connection may be configured for transmitting digital signals. The point-to-point-connection may be configured for transmitting mixed signals. The serial bus may be the primary communication path within the electronic control unit. The point-to-point connection may be a backup communication path in case of failure events. Thus, the electronic control unit may also dispense with the redundant point-to-point connection and only comprise the serial bus. Each point-to-point connection may require an additional pin at the central microcontroller, whereas the serial bus may only require one pin and may connect the central microcontroller to a plurality of digital drivers. Thus, by using the serial bus many pins as well as corresponding hardware resources, e.g. input/output electronics, can be saved at the central microcontroller, which may again reduce overall complexity and cost.

The central microcontroller may be configured for transmitting at least one of an ON signal, an OFF signal and a pulse width modulation (PWM) signal via the at least one point-to-point connection to at least one digital driver of the plurality of digital drivers. Specifically, the central microcontroller may be configured for transmitting at least one of an ON signal, an OFF signal and a PWM signal to all digital driver drivers, or at least to selected digital drivers, via separate point-to-point connections. In other words, the central microcontroller may be configured for transmitting an ON signal, an OFF signal or a PWM signal to a digital driver via a point-to-point connection. The ON signal or the OFF signal may be configured for putting the digital driver and/or the load in a safe state, specifically in case of a failure event. Accordingly, the safe state may specifically be a safe ON state or a safe OFF state. However, other options for the safe state may generally also be feasible. The PWM signal may be configured for controlling the digital driver and further on the load, specifically also in case of a failure event. The digital drivers may be configured for transmitting at least one piece of information via the serial bus to the central microcontroller. Additionally or alternatively, the digital drivers may be configured for transmitting the piece of information via the point-to-point connection to the central microcontroller, specifically in case of a failure event. The central microcontroller may be configured for receiving and processing the piece of information. The piece of information may be selected from the group consisting of: a configuration information; a status information; a diagnosis information. The piece of information may be a piece of information on the digital driver or on the load. The piece of information may comprise sensor data from at least one sensor observing the digital driver or the load. Thus, the piece of information may indicate a failure event, e.g. at the digital driver or at the load. Other failure events, e.g. at the central microcontroller or at the interconnection may also feasible.

The central microcontroller may be configured for sending at least one command via the serial bus to at least one digital driver. The digital driver may be configured for receiving and executing the command. The command may be defined in the communication protocol. Thus, the command may be a standardized command. The digital driver may be configured for understanding or following or interpreting the command. The command may be or may comprise a digital signal or a data package. The command may comprise an address, such as an address of a recipient of the command or an address of a sender of the command. The command may comprise an error checking measure, e.g. a checksum. Further options may be feasible. Specifically, the command may be a general command. The general command may be transmitted to all digital drivers. The general command may be received and understood by all digital drivers.

The term “general command” as generally used herein is a broad term and is to be given its ordinary and customary meaning to a person of ordinary skill in the art and is not to be limited to a special or customized meaning. The general command may be a command or an instruction which may be sent out globally to all connected devices, specifically to all digital drivers, more specifically to all digital drivers in one network. The general command may be a command or an instruction which may be understood globally by all connected devices, specifically by all digital drivers, more specifically by all digital drivers in one network. The general command may comprise an address, such as an address in a command register. The address may specifically be stored in each command register of each digital driver. The general command may be a broadcasted command. Thus, the general command may be broadcasted in a network. The terms “general call”, “general address” or “target address” may be used synonymously to the term “general command”. Thus, the general command may specifically not be sent only to a selected group of devices, which may require knowing their addresses before. The general command may not require an acknowledgement of a receiver of the general command. Thus, the central microcontroller may be configured for sending a general command via one serial bus to all digital drivers in one network or in the entire electronic control unit and all digital drivers may be configured for interpreting the general command.

The central microcontroller may be configured for assigning an address from the set of addresses defined in the communication protocol to at least one digital driver, specifically to each digital driver, such that each digital driver has an address. For this purpose, the central microcontroller may send a general command to all digital drivers of the electronic control unit or of at least of a network, which may not require that the digital drivers already have an address. Other options may be feasible. The addresses may also be determined and assigned from externally for instance. In any case, each digital driver of the electronic control unit or at least within a network may be assigned with an address, specifically with a unique address. Thus, each digital driver may have a unique address. Specifically, each digital driver within a network may have a unique address. Further, each digital driver of the electronic control unit may have a unique address. Thus, each digital driver may be unambiguously addressable with a command by the central microcontroller.

The communication protocol may comprise at least one safety concept. The term “safety concept” as generally used herein is a broad term and is to be given its ordinary and customary meaning to a person of ordinary skill in the art and is not to be limited to a special or customized meaning. The safety concept may be or may comprise a set of regulations or guidelines for ensuring safety or security or integrity of a device, specifically of the electronic control unit or at least of a part thereof. The safety concept may be or may comprise a set of measures which may be taken for maintaining or recovering operation of the device, at least to a sufficient extent for a given application or at least with acceptable limitations. Specifically, the safety concept may comprise a set of rules or procedures for preventing an accidental or intentional disruption of communication in the device, specifically between the central microcontroller and the digital drivers. Being part of the communication protocol, the safety concept may be standardized. The safety concept may increase an overall safety and stability of operation of the electronic control unit.

The safety concept may comprise at least one watchdog, also referred to as watchdog timer or computer operating properly timer (COP timer). Thus, the electronic control unit, e.g. the central microcontroller, may comprise at least one watchdog. The term “watchdog” as generally used herein is a broad term and is to be given its ordinary and customary meaning to a person of ordinary skill in the art and is not to be limited to a special or customized meaning. The watchdog may be configured for monitoring operation of a device, specifically the electronic control unit or at least a part thereof. The watchdog may be configured for detecting and/or correcting a failure event. The watchdog may at least be configured for initiating a corrective action in case of a failure event. The watchdog may be implemented in software and/or in hardware. The watchdog may comprise at least one timer. The timer may be set to a predetermined time interval. The watchdog may be configured for triggering a corrective action in case the timer is not reset, e.g. by the central microprocessor, before the set time interval is over. The corrective action may for instance be a controlled shutdown or a restart of the electronic control unit or at least a part thereof. Other options may be feasible. Specifically, the corrective action may comprise putting the electronic control unit or at least parts thereof in a safe state.

The safety concept may comprise at least one safe state for at least one digital driver. The term “safe state” as generally used herein is a broad term and is to be given its ordinary and customary meaning to a person of ordinary skill in the art and is not to be limited to a special or customized meaning. The safe state may be a state or a condition in which a device, specifically the electronic control unit or at least a part thereof, is considered to be safe or secure or stable. The safe state may be defined by using a set of criteria or parameters which may have to be met in order for the device to function, at least to a sufficient extent for a given application or at least with acceptable limitations. The safe state may also be an OFF state of the device, specifically in case a further operation of the device may be considered as too dangerous. As an example, in an automotive application, a further operation of a device in a failure event may put passengers in danger, such that a controlled shutdown of the automobile or at least a part thereof may be preferred. Thus, the safe state may be a safe OFF state. Further, the safe state may be a safe ON state. In some situations, a further operation may be considered safer than a shutdown. Summarizing, the safe state may comprise at least one of a safe ON state and a safe OFF state.

The communication protocol may comprise a sleep command for at least one digital driver. Specifically, the safety concept may comprise the sleep command. As said, the electronic control unit comprises a plurality of digital drivers. The digital drivers may send digital signals to the central microcontroller via a serial bus. Thus, one digital driver may block the serial bus for the further digital drivers. The central microcontroller may be configured for sending the sleep command to at least one digital driver, specifically to a digital driver blocking the serial bus, which may also be referred to as babbling idiot. The digital drivers may each comprise a clock. A clock of a digital driver may be switched off when executing the sleep command. This may stop the digital driver blocking the serial bus. Further, it may reduce overall power consumption. The communication protocol may comprise a wake-up command for at least one digital driver. Specifically, the safety concept may comprise the wake-up command. The central microcontroller may be configured for sending the wake-up command to at least one digital driver, specifically to a digital driver which was put to sleep before. A clock of the digital driver may be switched on when executing the wake-up command.

The electronic control unit may further comprise at least one supply connection to an external power supply, e.g. a battery. The electronic control unit may further comprise at least one discrete electronic device, e.g. a discrete transistor or sensor. The electronic control unit may comprise at least one discrete connection to the discrete electronic device, specifically a point-to-point connection. The electronic control unit may further comprise at least one network connection to at least one external network. The network connection may be selected from the group consisting of: a serial peripheral interface (SPI), a local interconnect network (LIN), a controller area connection (CAN); an ethernet connection. Thus, the electronic control unit may be part of a superior network, e.g. one of the above indicated. The electronic control unit may be connected to at least one external supervising controller, e.g. an external supervising electronic control unit.

In a further aspect, a method for controlling a load by using an electronic control unit is presented. The method comprises:
a) generating a command by using a central microcontroller of the electronic control unit;
b) sending the command to a digital driver of the electronic control unit by transmitting a digital signal via a serial bus of the electronic control unit; and
c) executing the command in the digital driver for controlling the load.

The method may further comprise:
d) generating at least one piece of information by using the digital driver;
e) sending the piece of information to the central microcontroller by transmitting a digital signal via the serial bus; and
f) processing the piece of information by using the central microcontroller.

The piece of information may be selected from the group consisting of: a configuration information, a status information; a diagnosis information. Other options may be feasible. Sending the command and/or the piece of information via the serial bus may specifically be performed by using a communication protocol. The electronic control unit may be an electronic control unit according to any one of the embodiments referring to an electronic control unit as described above or below in further detail. Thus, as said, the electronic control unit may for instance be arranged on a PCB, such that signal transmission may take place on the PCB. Throughout the present disclosure, the presented method steps may be performed in the indicated order. It shall be noted, however, that a different order may also be possible. The method may comprise further method steps which are not listed. Further, one or more of the method steps may be performed once or repeatedly. Further, two or more of the method steps may be performed simultaneously or in a timely overlapping fashion. The method may at least partially be computer-implemented. For further embodiments and definitions regarding the method, reference may be made to the embodiments and definitions outlined with respect to the electronic control unit. Specifically, as the skilled person will immediately understand, the method may also make use of the outlined point-to-point connections as well as of the safety concept of the communication protocol. Thus, as an example, the command and/or the piece of information may also be sent via the point-to-point connections, specifically in case of a failure event.

In a further aspect, a use of an electronic control unit or a method for controlling a load by using an electronic control unit is presented for an automotive application. In other words, the electronic control unit and/or the method may specifically be used for an automotive application. Other uses may of course also be feasible as the skilled person will immediately recognize. The electronic control unit is an electronic control unit according to any one of the embodiments referring to an electronic control unit as described above or below in further detail. The method is a method according to any one of the embodiments referring to a method as described above or below in further detail.

The devices and methods presented herein have considerable advantages over the prior art as already indicated throughout the description. They may save pins and hardware resources at a central microcontroller due to using a serial bus. In this context, they may also save PCB space. Using a communication protocol, specifically a standardized communication protocol or a network protocol, may further reduce software complexity and thus increase software reliability. This may also increase overall safety, specifically when defining a safety concept in the communication protocol.

As used herein, the terms “have”, “comprise” or “include” or any arbitrary grammatical variations thereof are used in a non-exclusive way. Thus, these terms may both refer to a situation in which, besides the feature introduced by these terms, no further features are pre-sent in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The disclosure may, as the skilled person will recognize, be performed by using alternative features. Similarly, features introduced by “in an embodiment of the disclosure” or similar expressions are intended to be optional features, without any restriction regarding alternative embodiments of the disclosure, without any restrictions regarding the scope of the disclosure and without any restriction regarding the possibility of combining the features introduced in such way with other optional or non-optional features of the disclosure.

Summarizing and without excluding further possible embodiments, the following Embodiments may be envisaged:

Embodiment 1: An electronic control unit comprising:
a plurality of digital drivers, each digital driver being configured for controlling at least one load;
a central microcontroller configured for controlling the digital drivers; and
an interconnection for communication between the central microcontroller and the digital drivers, the interconnection comprising:
   at least one serial bus configured for transmitting digital signals between the central microcontroller and the digital drivers; and
   at least one communication protocol comprising a set of commands and a set of addresses for communication.

Embodiment 2: The electronic control unit according to the preceding Embodiment, wherein the electronic control unit comprises a plurality of networks, wherein the interconnection comprises a plurality of serial busses and interconnects the networks, wherein each network comprises the central microcontroller, a serial bus and at least one digital driver.

Embodiment 3: The electronic control unit according to the preceding Embodiment, wherein the digital drivers in one network are all configured for controlling one type of load.

Embodiment 4: The electronic control unit according to any one of the preceding Embodiments, wherein the load comprises a device selected from the group consisting of: a motor, specifically a direct current motor, more specifically a brushed direct current motor or a brushless direct current motor; a switch, specifically a power distribution switch; a sensor; an actuator.

Embodiment 5: The electronic control unit according to any one of the preceding Embodiments, wherein the electronic control unit is arranged on a printed circuit board (PCB).

Embodiment 6: The electronic control unit according to any one of the preceding Embodiments, wherein the communication protocol is a standardized communication protocol.

Embodiment 7: The electronic control unit according to any one of the preceding Embodiments, wherein the communication protocol is a network protocol.

Embodiment 8: The electronic control unit according to any one of the preceding Embodiments, wherein the digital drivers are network compatible.

Embodiment 9: The electronic control unit according to any one of the preceding Embodiments, wherein the serial bus comprises at least one signal line.

Embodiment 10: The electronic control unit according to any one of the preceding Embodiments, wherein the serial bus comprises at least one of a clock line and one or more data lines.

Embodiment 11: The electronic control unit according to any one of the preceding Embodiments, wherein the serial bus is selected from the group consisting of: an inter-integrated circuit (I²C); a universal asynchronous receiver-transmitter (UART); a serial peripheral interface (SPI); or a combination thereof.

Embodiment 12: The electronic control unit according to any one of the preceding Embodiments, wherein the interconnection further comprises:
at least one point-to-point connection from the central microcontroller to at least one digital driver of the plurality of digital drivers.

Embodiment 13: The electronic control unit according to the preceding Embodiment, wherein the point-to-point connection is configured for transmitting analog signals.

Embodiment 14: The electronic control unit according to any one of the two preceding Embodiments, wherein the point-to-point connection is configured for transmitting digital signals.

Embodiment 15: The electronic control unit according to any one of the three preceding Embodiments, wherein the central microcontroller is configured for transmitting at least one of an ON signal, an OFF signal and a pulse width modulation (PWM) signal via the at least one point-to-point connection to at least one digital driver of the plurality of digital drivers.

Embodiment 16: The electronic control unit according to any one of the four preceding Embodiments, wherein the point-to-point connection is configured for serving as a redundancy for the serial bus.

Embodiment 17: The electronic control unit according to any one of the preceding Embodiments, wherein the digital drivers are configured for transmitting at least one piece of information via the serial bus to the central microcontroller, wherein the central microcontroller is configured for receiving and processing the piece of information.

Embodiment 18: The electronic control unit according to the preceding Embodiment, wherein the piece of information is selected from the group consisting of: a configuration information; a status information; a diagnosis information.

Embodiment 19: The electronic control unit according to any one of the preceding Embodiments, wherein the digital driver is a gate driver.

Embodiment 20: The electronic control unit according to any one of the preceding Embodiments, wherein the central microcontroller is configured for sending at least one command via the serial bus to at least one digital driver, wherein the digital driver is configured for receiving and executing the command, wherein the command is defined in the communication protocol.

Embodiment 21: The electronic control unit according to the preceding Embodiment, wherein the command is a general command, wherein the general command is transmitted to all digital drivers.

Embodiment 22: The electronic control unit according to any one of the preceding Embodiments, wherein the central microcontroller is configured for assigning an address from the set of addresses defined in the communication protocol to at least one digital driver.

Embodiment 23: The electronic control unit according to any one of the preceding Embodiments, wherein each digital driver has a unique address.

Embodiment 24: The electronic control unit according to any one of the preceding Embodiments, wherein the communication protocol comprises at least one safety concept.

Embodiment 25: The electronic control unit according to the preceding Embodiment, wherein the safety concept comprises at least one watchdog.

Embodiment 26: The electronic control unit according to any one of the two preceding Embodiments, wherein the safety concept comprises at least one safe state for at least one digital driver.

Embodiment 27: The electronic control unit according to the preceding Embodiment, wherein the safe sate comprises at least one of a safe ON state and a safe OFF state.

Embodiment 28: The electronic control unit according to any one of the preceding Embodiments, wherein the communication protocol comprises a sleep command for at least one digital driver.

Embodiment 29: The electronic control unit according to the preceding Embodiment, wherein a clock of the digital driver is switched off when executing the sleep command.

Embodiment 30: The electronic control unit according to any one of the preceding Embodiments, wherein the communication protocol comprises a wake-up command for at least one digital driver.

Embodiment 31: The electronic control unit according to the preceding Embodiment, wherein a clock of the digital driver is switched on when executing the wake-up command.

Embodiment 32: The electronic control unit according to any one of the preceding Embodiments, further comprising at least one supply connection to at least one external power supply.

Embodiment 33: The electronic control unit according to any one of the preceding Embodiments, further comprising at least one discrete electronic device and at least one discrete connection to the discrete electronic device.

Embodiment 34: The electronic control unit according to any one of the preceding Embodiments, further comprising at least one network connection to at least one external network.

Embodiment 35: The electronic control unit according to the preceding Embodiment, wherein the network connection is selected from the group consisting of: a serial peripheral interface (SPI), a local interconnect network (LIN), a controller area connection (CAN); an ethernet connection.

Embodiment 36: The electronic control unit according to any one of the preceding Embodiments, wherein the electronic control unit is an automotive electronic control unit.

Embodiment 37: The electronic control unit according to any one of the preceding Embodiments, wherein the electronic control unit is a zone electronic control unit.

Embodiment 38: A method for controlling a load by using an electronic control unit, the method comprising:
a) generating a command by using a central microcontroller of the electronic control unit;
b) sending the command to a digital driver of the electronic control unit by transmitting a digital signal via a serial bus of the electronic control unit; and
c) executing the command in the digital driver for controlling the load.

Embodiment 39: The method according to the preceding Embodiment, wherein the electronic control unit is an electronic control unit according to any one of the preceding Embodiments referring to an electronic control unit.

Embodiment 40: The method according to any one of the preceding method Embodiments, further comprising:
d) generating at least one piece of information by using the digital driver;
e) sending the piece of information to the central microcontroller by transmitting a digital signal via the serial bus; and
f) processing the piece of information by using the central microcontroller.

Embodiment 41: The method according to the preceding Embodiment, wherein the piece of information is selected from the group consisting of: a configuration information, a status information; a diagnosis information.

Embodiment 42: A use of an electronic control unit according to any one of the preceding Embodiments referring to an electronic control unit or of a method according to any one of the preceding method Embodiments for an automotive application.

Further optional features and embodiments will be disclosed in more detail in the subsequent description of embodiments, preferably in conjunction with the dependent embodiments. Therein, the respective optional features may be realized in an isolated fashion as well as in any arbitrary feasible combination, as the skilled person will realize. The scope of the disclosure is not restricted by the preferred embodiments. The embodiments are schematically depicted in the Figures. Therein, identical reference numbers in these Figures refer to identical or functionally comparable elements.

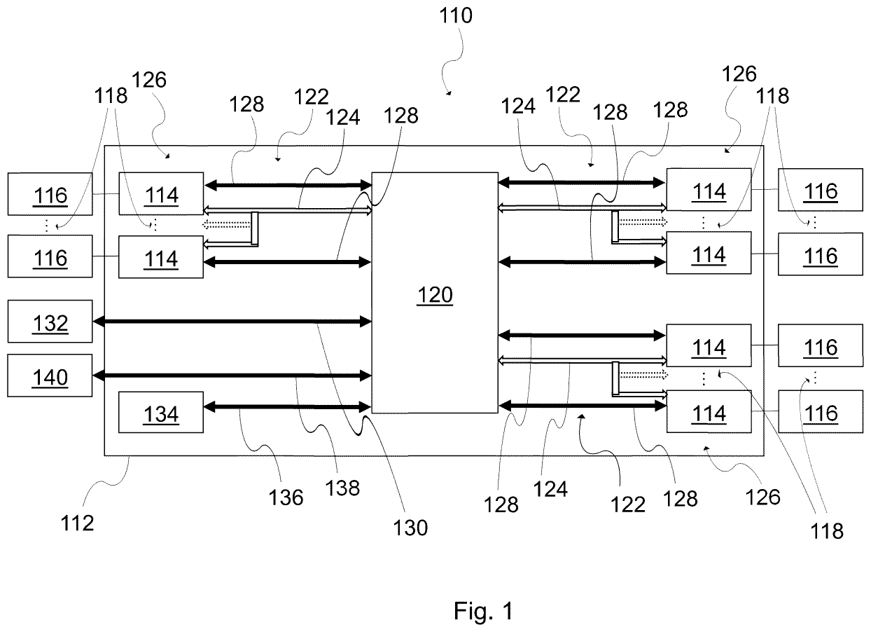

FIG. 1 schematically illustrates an exemplary embodiment of an electronic control unit 110. The electronic control unit 110 may be an automotive electronic control unit. Further, the electronic control unit 110 may be a zone electronic control unit or a central electronic control unit, specifically of an automobile. The electronic control unit 110 may be arranged on a printed circuit board (PCB) 112. Thus, components of the electronic control unit 110 may be positioned on the PCB 112. The electronic control unit 110 comprises a plurality of digital drivers 114. Each digital driver 114 is configured for controlling at least one load 116. Each digital driver 114 may be connected to one or more loads 116, specifically by a wired connection. The loads 116 may be external loads. Specifically, the loads 116 may be outside of the PCB 112. The load 116 may comprise a device selected from the group consisting of: a motor, specifically a direct current motor, more specifically a brushed direct current motor or a brushless direct current motor; a switch, specifically a power distribution switch; a sensor; an actuator. The digital drivers 114 may specifically be gate drivers. Dots 118 indicate that many more digital drivers 114 having corresponding loads 116 may be part of the electronic control unit 110 compared to the limited number that can only be shown in FIG. 1 due to space restrictions.

The electronic control unit 110 further comprises a central microcontroller 120. The central microcontroller 120 is configured for controlling the digital drivers 114. The central microcontroller 120 may be connected to all digital drivers 114 of the electronic control unit 110. In other words, each digital driver 114 may be connected to the central microcontroller 120. The electronic control unit 110 comprises an interconnection 122 for communication between the central microcontroller 120 and the digital drivers 114. Specifically, the interconnection 122 may connect the central microcontroller 120 to all digital drivers 114. Thus, the central microcontroller 120 may be configured for communicating with all digital drivers 114 via the interconnection 122. The interconnection 122 comprises at least one serial bus 124. The serial bus 124 is configured for transmitting digital signals between the central microcontroller 120 and the digital drivers 114. As said, the electronic control unit 110 may be arranged on a PCB 112. Thus, the digital drivers 114, the central microcontroller 120 and the interconnection 122, specifically the serial bus 124, may all be arranged on the PCB 112.

The serial bus 124 may connect the central microcontroller 120 and the digital drivers 114. Connections to the digital drivers 114 which are not explicitly shown in FIG. 1 due to space restrictions, which are however indicated by the dots 118, are indicated by corresponding dotted arrows at the serial bus 124. Each dotted arrow may thus actually represent a plurality of connections, specifically one connection to each indicated digital driver 114. Thus, the serial bus 124 may comprise physical connections between the central microcontroller 120 and the digital drivers 114, e.g. traces on the PCB 112. Specifically, the serial bus 124 may comprise at least one signal line. The serial bus 124 may be configured for transmitting signals sequentially via the signal line. The serial bus 124 may specifically be a digital serial bus. Thus, the serial bus 124 may be configured for transmitting digital signals bit-by-bit via the signal line. The serial bus 124 may comprise at least one of a clock line and one or more data lines, e.g. two data lines. The serial bus 124 may be selected from the group consisting of: an inter-integrated circuit (I²C); a universal asynchronous receiver-transmitter (UART); a serial peripheral interface (SPI); or a combination thereof.

The electronic control unit 110 may comprise a plurality of networks 126. The interconnection 122 may comprise a plurality of serial busses 124 and may interconnect the networks 126. Each network 126 may comprise the central microcontroller 120, a serial bus 124 and at least one digital driver 114, specifically a plurality of interconnected digital drivers 114. In other words, a plurality of digital drivers 114 and the central microcontroller 120 may form a network 126. Each network 126 may completely be interconnected through one serial bus 124. Thus, all digital drivers 114 of one network 126 may be connected to each other and to the central microcontroller 120 through one serial bus 124. In other words, one serial bus 124 may interconnect the central microcontroller 120 and all digital drivers 114 in one network 126. The digital drivers 114 in one network 126 may all be configured for controlling one type of load, e.g. a brushless direct current motor. The digital drivers 114 in a further network 126 may all be configured for controlling a further type of load, e.g. a power distribution switch. Thus, overall, the electronic control unit 110 may comprise a plurality of specialized networks 126 for different types of loads. The digital drivers 114 of one network 126 may not be directly connected to the digital drivers 114 of a further network 126. The central microcontroller 120 may be part of all networks 126.

The interconnection 122 further comprises at least one communication protocol. The communication protocol comprises a set of commands and a set of addresses for communication. The communication protocol may be a network protocol. The network protocol may be standardized. More generally, the communication protocol may be a standardized communication protocol. The digital drivers 114 may be network compatible. Thus, the digital drivers 114 may be configured for communicating with each other and/or with the central microcontroller 120 within one network 126. The digital drivers 114 may be smart digital drivers. The digital drivers 114 may specifically be configured for understanding the network protocol. Thus, the digital drivers 114 may comprise required hardware elements for this purpose, such as specific logic circuits, or they may be peripheral microcontrollers. The communication protocol may comprise at least one safety concept. The safety concept may comprise at least one watchdog. Thus, the electronic control unit 110, e.g. the central microcontroller 120, may comprise at least one watchdog. The safety concept may comprise at least one safe state for at least one digital driver 114. The safe state may comprise at least one of a safe ON state and a safe OFF state. The communication protocol may comprise a sleep command for at least one digital driver 114. A clock of the digital driver 114 may be switched off when executing the sleep command. Accordingly, the communication protocol may comprise a wake-up command for at least one digital driver 114. A clock of the digital driver 114 may be switched on when executing the wake-up command.

The interconnection 122 may further comprise at least one point-to-point connection 128 from the central microcontroller 120 to at least one digital driver 114 of the plurality of digital drivers 114. The point-to-point connection 128 may be a physical connection, e.g. a trace on the PCB 112. The interconnection 122 may specifically comprise a separate point-to-point connection 128 from the central microcontroller 120 to each digital driver 114. The point-to-point connection 128 may be configured for serving as a redundancy for the serial bus 124, specifically in case of a failure event. Each point-to-point connection 128 may connect the central microcontroller 120 to exactly one digital driver 114. The serial bus 124 may be the primary communication path within the electronic control unit 110. The point-to-point connection 128 may be a backup communication path in case of failure events. The point-to-point connection 128 may be separate from the serial bus 124. The point-to-point 128 connection may be configured for transmitting analog signals. Additionally or alternatively, the point-to-point connection 128 may be configured for transmitting digital signals. The point-to-point-connection 128 may be configured for transmitting mixed signals.

As shown in FIG. 1, the interconnection may specifically comprise a plurality of point-to-point connections 128. The central microcontroller 120 may be configured for transmitting at least one of an ON signal, an OFF signal and a pulse width modulation (PWM) signal via the point-to-point connections 128 to the digital drivers 114. In other words, the central microcontroller 120 may be configured for transmitting an ON signal, an OFF signal or a PWM signal to a digital driver 114 via a separate point-to-point connection 128. Specifically, the central microcontroller 120 may be configured for transmitting an ON signal, an OFF signal or a PWM signal to all digital driver drivers 114 via separate point-to-point connections 128. The digital drivers 114 may be configured for transmitting at least one piece of information via the serial bus 124 to the central microcontroller 120. Additionally or alternatively, the digital drivers 114 may be configured for transmitting the piece of information via the point-to-point connections 128 to the central microcontroller 120, specifically in case of a failure event. The central microcontroller 120 may be configured for receiving and processing the piece of information. The piece of information may be selected from the group consisting of: a configuration information; a status information; a diagnosis information. The piece of information may for instance be a piece of information about the digital driver 114 or about the load 116.

The central microcontroller 110 may be configured for sending at least one command via the serial bus 124 to at least one digital driver 114. The digital driver 114 may be configured for receiving and executing the command. The command may be defined in the communication protocol. Thus, the command may be a standardized command. The digital driver 114 may be configured for understanding the command. The command may be a general command. The general command may be transmitted to all digital drivers 114. Specifically, the general command may be sent out from the central microcontroller 120 to all digital drivers 114 of one network 126 or to all digital drivers 114 of the electronic control unit 110. The central microcontroller 120 may be configured for assigning an address from the set of addresses defined in the communication protocol to at least one digital driver 114, specifically to each digital driver 114 of the electronic control unit 110 or at least of a network 126. Specifically, each digital driver 114 may have a unique address.

The electronic control unit 110 may further comprise at least one supply connection 130 to an external power supply 132, e.g. a battery. Thus, the power supply may be located outside of the PCB 112. The electronic control unit 110 may further comprise at least one discrete electronic device 134, e.g. a discrete transistor or sensor. The electronic control unit 110 may comprise at least one discrete connection 136 to the discrete electronic device 134. The electronic control unit 110 may further comprise at least one network connection 138 to at least one external network 140. The network connection 138 may be selected from the group consisting of: a serial peripheral interface (SPI), a local interconnect network (LIN), a controller area connection (CAN); an ethernet connection.

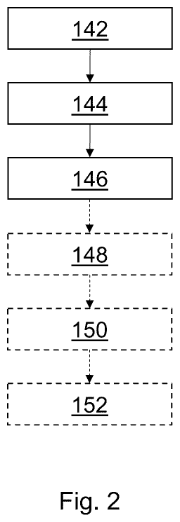

FIG. 2 illustrates a flow chart of an exemplary embodiment of a method for controlling a load 116 by using an electronic control unit 110. The method comprises:
a) (denoted with reference numeral 142) generating a command by using a central microcontroller 120 of the electronic control unit 110;
b) (denoted with reference numeral 144) sending the command to a digital driver 114 of the electronic control unit 110 by transmitting a digital signal via a serial bus 124 of the electronic control unit 110; and
c) (denoted with reference numeral 146) executing the command in the digital driver 114 for controlling the load 116.

The method may further comprise:
d) (denoted with reference numeral 148) generating at least one piece of information by using the digital driver 114;
e) (denoted with reference numeral 150) sending the piece of information to the central microcontroller 120 by transmitting a digital signal via the serial bus 124; and
f) (denoted with reference numeral 152) processing the piece of information by using the central microcontroller 120.

The piece of information may be selected from the group consisting of: a configuration information, a status information; a diagnosis information. Sending the command and/or the piece of information via the serial bus 124 may specifically be performed by using a communication protocol. Further, the command and/or the piece of information may also be sent via the point-to-point connections 128, specifically in a failure event. The electronic control unit 110 may specifically be an electronic control unit 110 according to any one of the embodiments referring to the electronic control unit 110 as described above or below in further detail. Throughout the present disclosure, the presented method steps may be performed in the indicated order. It shall be noted, however, that a different order may also be possible. The method may comprise further method steps which are not listed. Further, one or more of the method steps may be performed once or repeatedly. Further, two or more of the method steps may be performed simultaneously or in a timely overlapping fashion. The method may at least partially be computer-implemented. The method and/or the electronic control unit 110 may specifically be used for an automotive application.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the disclosure and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the disclosure, as well as specific examples thereof, are intended to encompass equivalents thereof.

1. An electronic control unit comprising:
a plurality of digital drivers, each digital driver being configured for controlling at least one load;
a central microcontroller configured for controlling the digital drivers; and
an interconnection for communication between the central microcontroller and the digital drivers, the interconnection comprising:
at least one serial bus configured for transmitting digital signals between the central microcontroller and the digital drivers; and
at least one communication protocol comprising a set of commands and a set of addresses for communication.

2. The electronic control unit of claim 1, wherein the electronic control unit comprises a plurality of networks, wherein the interconnection comprises a plurality of serial busses and interconnects the networks, wherein each network comprises the central microcontroller, a serial bus and at least one digital driver.

3. The electronic control unit of claim 1, wherein the electronic control unit is arranged on a printed circuit board (PCB).

4. The electronic control unit of claim 1, wherein the communication protocol is a standardized communication protocol.

5. The electronic control unit of claim 1, wherein the communication protocol is a network protocol.

6. The electronic control unit of claim 1, wherein the digital drivers are network compatible.

7. The electronic control unit of claim 1, wherein the interconnection further comprises:
at least one point-to-point connection from the central microcontroller to at least one digital driver of the plurality of digital drivers.

8. The electronic control unit of claim 7, wherein the point-to-point connection is configured for transmitting analog signals.

9. The electronic control unit of claim 8, wherein the point-to-point connection is configured for transmitting digital signals.

10. The electronic control unit of claim 9, wherein the central microcontroller is configured for transmitting at least one of an ON signal, an OFF signal and a pulse width modulation (PWM) signal via the at least one point-to-point connection to at least one digital driver of the plurality of digital drivers.

11. The electronic control unit of claim 1, wherein the central microcontroller is configured for sending at least one command via the serial bus to at least one digital driver, wherein the digital driver is configured for receiving and executing the command, wherein the command is defined in the communication protocol, wherein the command is a general command, wherein the general command is transmitted to all digital drivers.

12. The electronic control unit of claim 1, wherein the central microcontroller is configured for assigning an address from the set of addresses defined in the communication protocol to at least one digital driver.

13. The electronic control unit of claim 1, wherein the communication protocol comprises at least one safety concept.

14. The electronic control unit of claim 1, wherein the safety concept comprises at least one watchdog.

15. The electronic control unit of claim 1, wherein the safety concept comprises at least one safe state for at least one digital driver.

16. The electronic control unit of claim 1, wherein the communication protocol comprises a sleep command for at least one digital driver.

17. The electronic control unit of claim 1, wherein the communication protocol comprises a wake-up command for at least one digital driver.

18. A method for controlling a load by using an electronic control unit, the method comprising:
a) generating a command by using a central microcontroller of the electronic control unit;
b) sending the command to a digital driver of the electronic control unit by transmitting a digital signal via a serial bus of the electronic control unit; and
c) executing the command in the digital driver for controlling the load.

19. The method of claim 18, further comprising:
d) generating at least one piece of information by using the digital driver;
e) sending the piece of information to the central microcontroller by transmitting a digital signal via the serial bus; and
f) processing the piece of information by using the central microcontroller.

20. The method of claim 18, further comprising: using the method for an automotive application.
